(19) United States
(12) Patent Application Publication
(10) Pub. No.: US 2009/0017424 A1
(43) Pub. Date: Jan. 15, 2009

(54) COMBINED HEAD UP DISPLAY

(75) Inventors: Nahum Yoeli, Kiryat Haim (IL); Nissan Belken, Tel Aviv (IL)

Correspondence Address: MERCHANT & GOULD PC, P.O. BOX 2903, MINNEAPOLIS, MN, 55402-0903, US

(73) Assignee: ELBIT SYSTEMS LTD., HAIFA (IL)

(21) Appl. No.: 11/915,994

(22) PCT Filed: May 25, 2006
(86) PCT No.: PCT/IL06/00624

§ 371 Date: Jul. 21, 2008

(51) Int. Cl. G09B 9/00

(52) U.S. Cl. 434/44

(57) ABSTRACT

System for displaying an auxiliary image on a head-up display, the system including a panoramic projection screen, at least one panoramic projector for projecting a panoramic image on the panoramic projection screen, a beam combiner located between the panoramic projection screen and the audience, and an auxiliary projector for projecting the auxiliary image toward the beam combiner, the panoramic image being viewed by an audience. The beam combiner produces a combined image of the panoramic image and the auxiliary image, for the audience, by transmitting at least part of the panoramic image toward the audience, and by reflecting the auxiliary image toward the audience, such that the auxiliary image appears closer to the audience than the panoramic image.

### FIELD OF THE DISCLOSED TECHNIQUE

The disclosed technique relates to projection screens in general, and to systems and methods for demonstrating the operation of a head-up display (HUD) in a cockpit for an audience, in particular.

### BACKGROUND OF THE DISCLOSED TECHNIQUE

Systems and methods for displaying a projected image to an audience are known in the art. Such systems employ either a front projection screen or a rear projection screen to provide either a still or a video image for the audience. Head-up displays (HUD) are also known in the art. A HUD includes a projector to project an image of informative data, such as a symbol or a numeral, on to a glass screen located between a canopy of an aircraft and a pilot of the aircraft. In this manner, the pilot can obtain relevant information, such as the air speed, or a map, without having to look down to the gauges on the instrument panel. This HUD is usually in the general form of a rectangle a few inches on each side.

U.S. Pat. No. 6,870,670 B2 issued to Gehring et al., and entitled “Screens and Methods for Displaying Information”, is directed to a system for displaying information to viewers, such as pedestrians, customers, an audience, spectators, and drivers. The system includes a projector, a rear projection screen, an optical adhesive, and a transparent viewable surface. The rear projection screen includes a plurality of refractive elements, a light transmitting substrate, a light absorbing layer, and a backing. The refractive elements and the light absorbing layer are coated on one side of the light transmitting substrate. The optical adhesive is coated on the opposite side of the light transmitting substrate, and the backing covers the optical adhesive during storage, to be peeled off before attaching the rear projection screen to the transparent viewable surface.

The transparent viewable surface can be a window of a shop. The projector is located behind the rear projection screen, in order to display the image to the viewers through the transparent viewable surface, temporarily and for a predetermined period of time. Thereafter, the rear projection screen can be detached from the transparent viewable surface. The system further includes a central controller, a plurality of projectors, and a mass storage. The central controller is connected to the mass storage and to the projectors via a network. The projectors are spread in different geographical locations. A user can direct the central controller to transmit data respective of selected images, to selected projectors.

U.S. Pat. No. 4,025,160 issued to Martinez and entitled “Dual Purpose Projection Screen”, is directed to a projection screen for projecting an image to an audience at a wide viewing angle. The projection screen includes a plastic film having a front surface and a rear surface. The plastic film is translucent and milky white. Fine parallel random striations are formed on the rear surface, by the rotating action of a bristle brush, and a reflective metallic coating is applied to the parallel random striations. Light emitted by a projector toward the front surface, passes through the plastic film and is reflected from the reflective metallic coating in a lenticular manner. Due to the lenticular effect, the light is reflected in the horizontal plane at a greater angle relative to the central axis of the projector.

U.S. Pat. No. 4,962,420 issued to Judenich and entitled “Entertainment Video Information System Having a Multiplane Screen”, is directed to a video information system for displaying a plurality of images to an audience. The video information system includes a plurality of cells and a plurality of projectors. Each cell is in form of either a front projection screen or a rear projection screen, having either a vertical axis or a horizontal axis. Each cell can rotate about the respective axis. Each of the projectors projects a different image on the respective cell.

U.S. Pat. No. 6,577,355 B1 issued to Yaniv and entitled “Switchable Transparent Screens for Image Projection System”, is directed to a system for displaying a plurality of images to an audience. The system includes a projection screen and a plurality of projectors. The projection screen is made of a transparent material having a plurality of switchable portions. Each of the switchable portions can be switched between a transparent state and an opaque state, electrically or chemically. The projectors are located on either side of the projection screen. When a switchable portion is switched to an opaque state, the audience can view an image projected by the projector on the switchable portion.

U.S. Pat. No. 6,853,486 B2 issued to Cruz-Uribe et al., and entitled “Enhanced Contrast Projection Screen”, is directed to a display system to enhance the contrast of an image displayed to an audience in low ambient light conditions. The display system includes a computer, a reflectance processor, a light engine, a variable-reflectivity projection screen, and an electrode controller. The variable-reflectivity projection screen includes a plurality of display elements and a bias region located between the display elements. Each display element includes one or more active pixel elements.

The reflectance processor is connected with the computer, the light engine, and with the electrode controller. The electrode controller is connected with the active pixel elements. The electrode controller alters the reflectivity state of each of the active pixel elements. The reflectance processor converts the image data which is used by the light engine to generate an image projected on the variable-reflectivity projection screen, to corresponding reflectance states of the respective active pixel elements. Regions of the image projected on the variable-reflectance projection screen which have high luminance, benefit from projection onto active pixel elements which exhibit a high reflectance. Regions of the image projected on the variable-reflectance projection screen which have low luminance, benefit from projection onto active pixel elements which exhibit a low reflectance.

### SUMMARY OF THE DISCLOSED TECHNIQUE

It is an object of the disclosed technique to provide a novel method and system for demonstrating the operation of a HUD.

In accordance with the disclosed technique, there is thus provided a system for displaying an auxiliary image on a head-up display. The system includes a panoramic projection screen, at least one projector for projecting a panoramic image on the panoramic projection screen, a beam combiner located between the panoramic projection screen and the audience, and a projector for projecting the auxiliary image toward the beam combiner. The panoramic image is viewed by an audience. The beam combiner produces a combined image of the panoramic image and the auxiliary image, for the audience, by transmitting at least part of the panoramic image toward the audience, and by reflecting the auxiliary image toward the audience, such that the auxiliary image appears closer to the audience than the panoramic image.

In accordance with another embodiment of the disclosed technique, there is thus provided a method for displaying successively an auxiliary image on a head-up display. The method includes the procedures of directing at least one projector to project a panoramic image on a panoramic projection screen, directing a projector to project the auxiliary image toward a beam combiner, according to auxiliary image data, and producing a combined image of the panoramic image and the auxiliary image, for an audience.

The projectors project the panoramic image on the panoramic projection screen, according to panoramic image data. The beam combiner is located between the panoramic projection screen and the audience. The combined image is produced by transmitting the panoramic image toward the audience, by the beam combiner, and by deflecting the auxiliary image toward the audience, by the beam combiner, such that the auxiliary image appears closer to the audience than the panoramic image.

### BRIEF DESCRIPTION OF THE DRAWINGS

The disclosed technique will be understood and appreciated more fully from the following detailed description taken in conjunction with the drawings in which:

FIG. 1 is a schematic illustration of a system for displaying a panoramic image on a panoramic projection screen, and informative data on a beam combiner to an audience, constructed and operative in accordance with an embodiment of the disclosed technique;

FIG. 2 is a schematic illustration of a side view of the system of FIG. 1;

FIG. 3 is schematic illustration of a top view of the system of FIG. 1;

FIG. 4 is a block diagram of the system of FIG. 1;

FIG. 5A is a schematic illustration of an auxiliary image reflected by the beam combiner of the system of FIG. 1, toward an audience;

FIG. 5B is a schematic illustration of another auxiliary image simulating a cockpit reflected by the beam combiner against a panoramic image, toward the audience;

FIG. 5C is a schematic illustration of a further auxiliary image simulating a HUD displaying a map reflected toward the audience by the beam combiner against a panoramic image;

FIG. 5D is a schematic illustration of another auxiliary image simulating a HUD displaying informative data reflected toward the audience by the beam combiner against a panoramic image; and

FIG. 6 is a schematic illustration of a method for operating the system of FIG. 1, operative according to another embodiment of the disclosed technique.

### DETAILED DESCRIPTION OF THE EMBODIMENTS

The disclosed technique overcomes the disadvantages of the prior art by projecting a panoramic image for an audience, on a large and distant panoramic projection screen, and by projecting informative data on a beam combiner located between the panoramic projection screen and the audience, such that the image of the informative data appears to the audience at a distance closer than that of the panoramic projection screen. A system according to the disclosed technique simulates the operation of an actual head-up display (HUD) of an aircraft during flight, thereby enabling the audience to view the informative data against a panoramic view of a cockpit of the aircraft, as if the audience was flying the aircraft.

The term “auxiliary image” herein below refers to a video image, such as a menu including a plurality of simulation options, an image of a cockpit (not shown) of an aircraft (not shown) as seen by a pilot (not shown) of the aircraft, informative data (e.g., a two-dimensional map, a three-dimensional map, flight data), and the like. Alternatively, the auxiliary image is a still image. The term “panoramic image” herein below refers to a video image simulating a view of outside scenery as seen by a pilot from the cockpit. Alternatively, the panoramic image is a still image.

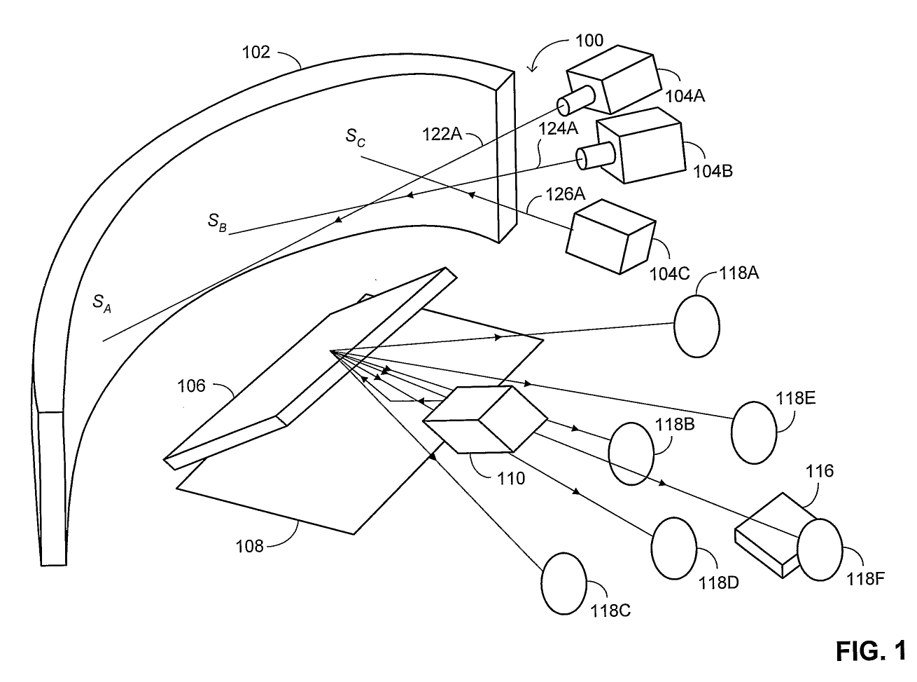

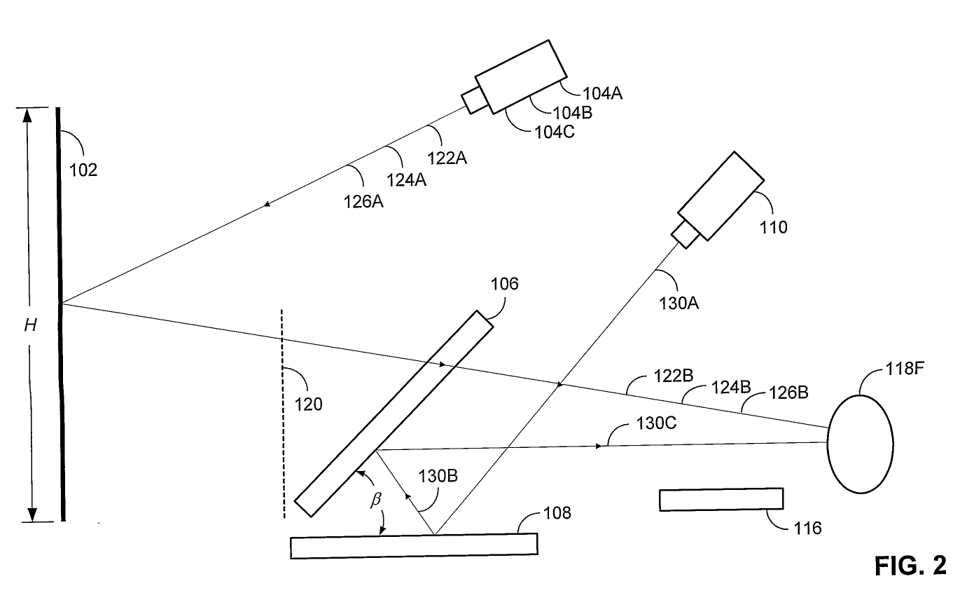

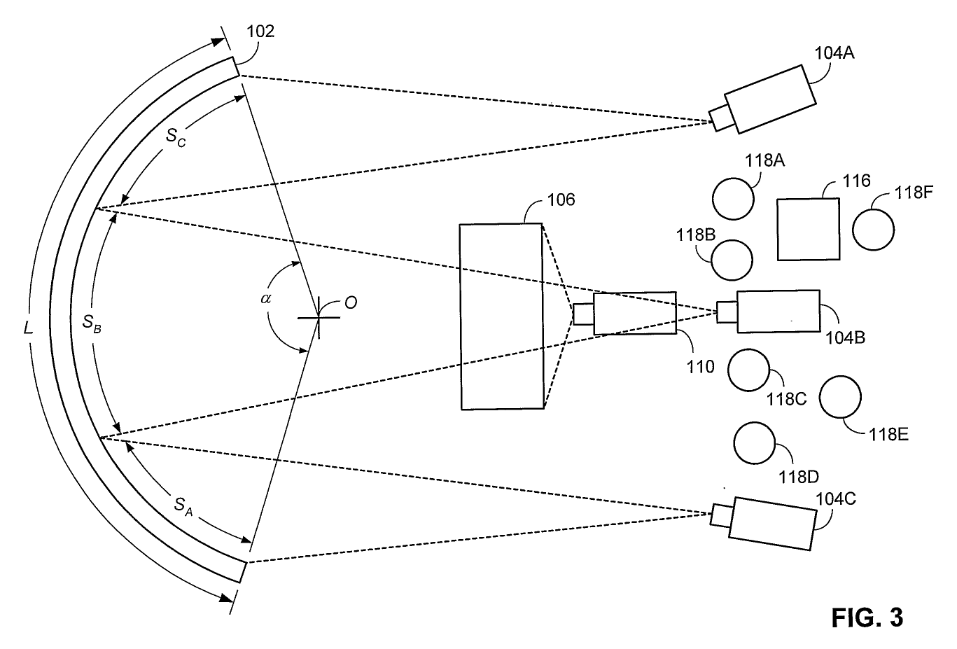

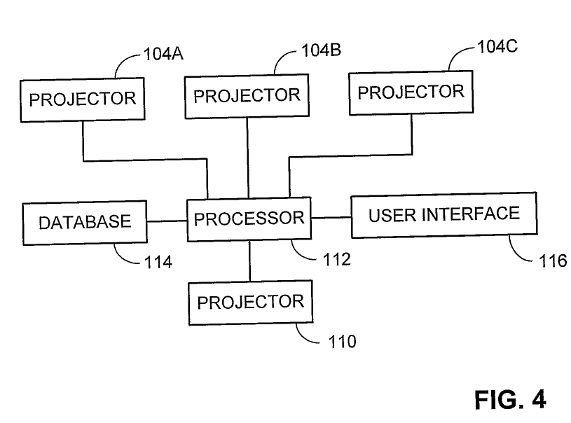

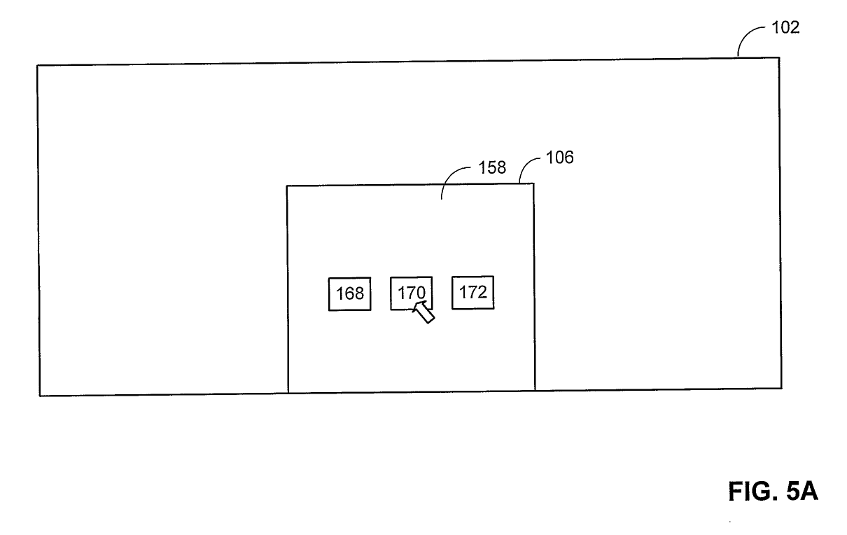

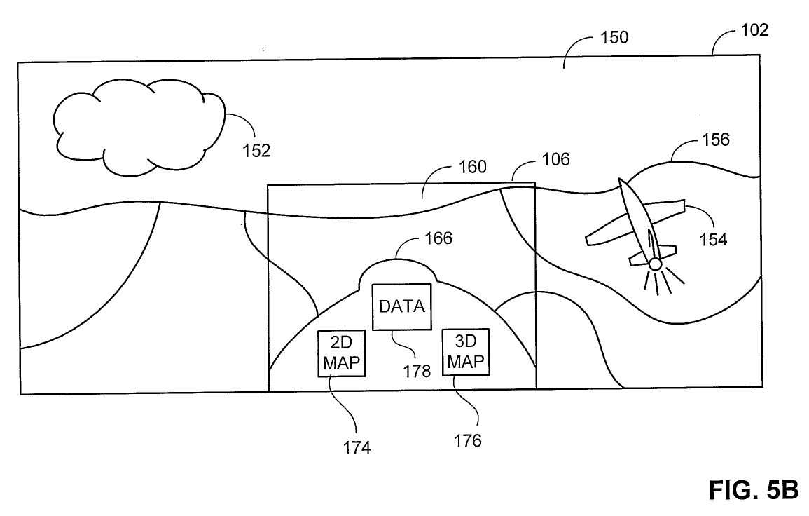

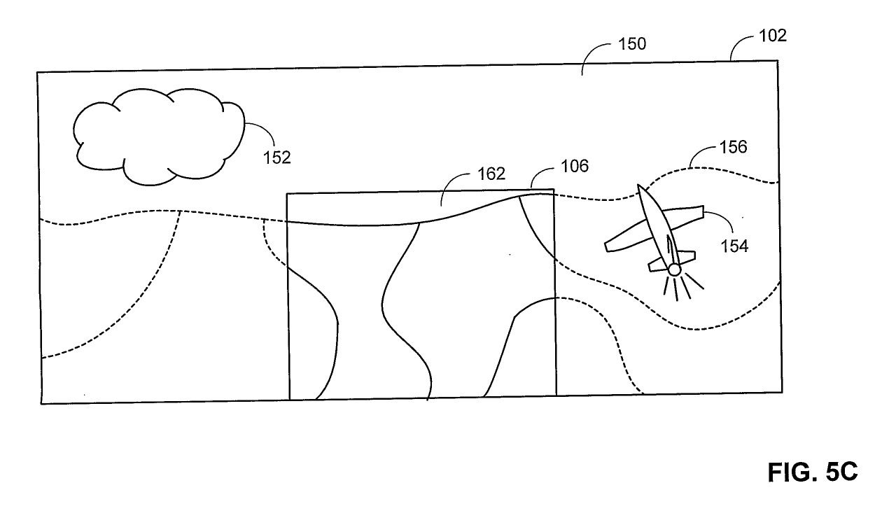

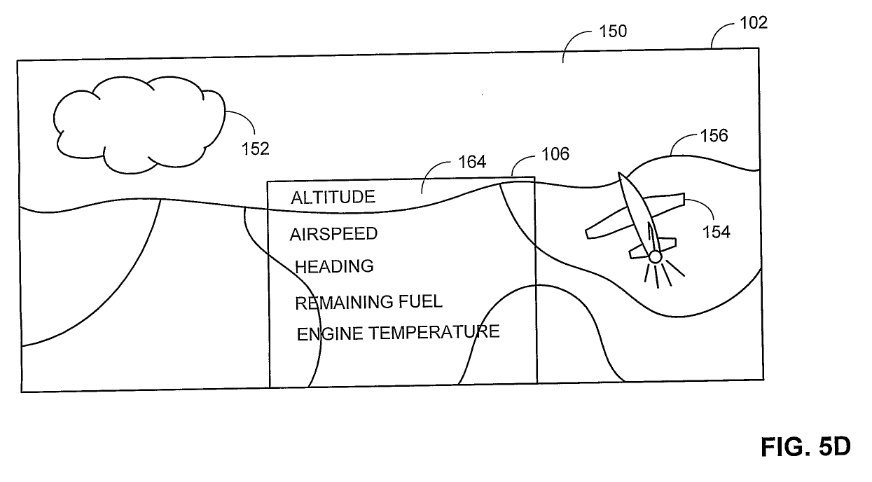

Reference is now made to FIGS. 1, 2, 3, 4, 5A, 5B, 5C and 5D. FIG. 1 is a schematic illustration of a system, generally referenced 100, for displaying a panoramic image on a panoramic projection screen, and informative data on a beam combiner to an audience, constructed and operative in accordance with an embodiment of the disclosed technique. FIG. 2 is a schematic illustration of a side view of the system of FIG. 1. FIG. 3 is schematic illustration of a top view of the system of FIG. 1. FIG. 4 is a block diagram of the system of FIG. 1. FIG. 5A is a schematic illustration of an auxiliary image reflected by the beam combiner of the system of FIG. 1, toward an audience. FIG. 5B is a schematic illustration of another auxiliary image simulating a cockpit reflected by the beam combiner against a panoramic image, toward the audience. FIG. 5C is a schematic illustration of a further auxiliary image simulating a HUD displaying a map reflected toward the audience by the beam combiner against a panoramic image. FIG. 5D is a schematic illustration of another auxiliary image simulating a HUD displaying informative data reflected toward the audience by the beam combiner against a panoramic image.

With reference to FIGS. 1 and 4, system 100 includes a panoramic projection screen 102, a plurality of projectors 104A, 104B, and 104C, a beam combiner 106, a reflector 108, a projector 110, a processor 112, a database 114, and a user interface 116. Processor 112 is coupled with projectors 104A, 104B, and 104C, projector 110, database 114, and with user interface 116, either with a wired link or by a wireless link. Beam combiner 106 is located between panoramic projection screen 102, and a plurality of viewers 118A, 118B, 118C, 118D, 118E (i.e., an audience), and an operator 118F. Panoramic projection screen 102 is relatively distant from the audience, for example 10 m away, such that the panoramic image simulates the real scenery as viewed from the cockpit of an aircraft by the pilot. To enhance the panoramic effect, panoramic projection screen 102 is preferably concave, such as cylindrical or spherical sector shaped. The relatively large dimensions of panoramic projection screen 102 provide for an image which is perceived by the audience to be substantially located an infinite distance away (i.e., panoramic projection screen 102 projects a panoramic image at infinity focus). It is noted that the proportions of the elements shown in FIGS. 1, 2, and 3 may be exaggerated and do not reflect actual sizes or distances of the various elements of system 100.

With reference to FIG. 3, a cross section of panoramic projection screen 102 is in the form of an arc of a sector of a circle (not shown) having a center O. This sector subtends an angle α, where α can be for example between 100 and 140 degrees. A length L of this arc can be for example in the scale of 10 m. With reference to FIG. 2, a height H of panoramic projection screen 102 can be for example between 3 m and 4 m.

Beam combiner 106 can be either transparent or semitransparent and can be made of a transparent sheet with a reflective coating, a substantially flat sheet of glass, a polymer, and the like. Beam combiner 106 can be in the form of a rectangle, for example having a length and width of between 1 m and 2 m. Beam combiner 106 is oriented at an inclination relative to the audience, e.g., at 45 degrees counterclockwise from the optical axis between beam combiner 106 and the audience, as best seen by angle β in FIG. 2.

Reflector 108 can be for example, made of cloth or a polymer impregnated with reflective particles such as metal beads. Reflector 108 is located below beam combiner 106. Projector 110 is located above both reflector 108 and beam combiner 106, such that projector 110 would not block the view of panoramic image by the audience. In the example set forth in FIGS. 1, 2, and 3, panoramic projection screen 102 is a front projection screen. Hence, projectors 104A, 104B, and 104C, are located above and in front of panoramic projection screen 102. Alternatively, the panoramic projection screen can be a rear projection screen, in which case the projectors are located behind the panoramic projection screen.

Projectors 104A, 104B, and 104C, project different portions of a panoramic image 150 (FIGS. 5B, 5C, and 5D), represented by light beams 122A (FIGS. 1 and 2), 124A, and 126A, on sections S_{A} (FIG. 3), S_{B}, and S_{C}, respectively, of panoramic projection screen 102. Panoramic image 150 includes an image 152 of clouds, an image 154 of an aircraft, and an image 156 of a landscape, which the pilot would see through the cockpit, and through a HUD (not shown) disposed in front of the pilot.

A method for producing a substantially seamless panoramic image of panoramic image 150 is described herein below. Panoramic projection screen 102 reflects light beams 122A, 124A, and 126A, as light beams 122B, 124B, and 126B, toward the audience, through beam combiner 106. The use of several projectors such as projectors 104A, 104B, and 104C is preferable with a relatively large and concave panoramic projection screen. It is possible to use a single projector for the panoramic projection screen, thus compromising quality and limiting the size, spread or curvature of the panoramic projection screen, and therefore reducing the reality-like experience provided by the panoramic image.

Projector 110 projects an auxiliary image, such as auxiliary image 158 (FIG. 5A), auxiliary image 160 (FIG. 5B), auxiliary image 162 (FIG. 5C), or auxiliary image 164 (FIG. 5D), represented by a light beam 130A (FIG. 2), on reflector 108. Reflector 108 reflects light beam 130A as a light beam 130B toward beam combiner 106, and beam combiner 106 reflects light beam 130B as a light beam 130C, toward the audience. Beam combiner 106 produces a combined image by combining light beams 122B, 124B, 126B, which are transmitted through beam combiner 106, with light beam 130C, which is reflected from beam combiner 106.

Hence, the audience can view some portions of panoramic image 150 directly, as reflected by panoramic projection screen 102, and other portions of panoramic image 150 indirectly, as transmitted through beam combiner 106. The audience can view each of auxiliary images 158, 160, 162, and 164 simultaneously, as reflected by beam combiner 106. Each of auxiliary images 158, 160, 162, and 164, is focused such that it appears to the audience as if it was located on an image plane 120. Image plane 120 is much closer to the audience than panoramic projection screen 102, thus providing an image resembling a closer object, for example the instrument panel in the cockpit as seen in FIG. 5B. Image plane 120 can be located for example between 2 m and 4 m from the audience.

Alternatively, an appropriate optical assembly (not shown) such as in projector 110, can also provide for a curved image surface or plane instead of image plane 120. For example, a cylindrical sector in conformity with the cylindrical sector shape of panoramic projection screen 102.

Panoramic image 150 is a video image of the external environment of the aircraft, as seen by the pilot through a canopy of the aircraft (e.g., images of other aircraft flying in the vicinity of the aircraft simulated by system 100, an image of the ground and objects thereon, atmospheric conditions, such as clouds, water droplets, lightning, and the like). Each of auxiliary images 158, 160, 162, and 164, is projected in synchrony with panoramic video image 150. For example, if auxiliary image 162 is a map, such as illustrated in FIG. 5C, the map corresponds to the actual scenery shown by panoramic video image 150. If auxiliary image 164 is informative data, such as illustrated in FIG. 5D, the informative data corresponds to the actual scenery shown by panoramic video image 150. If auxiliary image 160 is an image 166 of an instrument panel of a cockpit, such as illustrated in FIG. 5B, the maps and informative data of the instruments correspond to the actual scenery shown by panoramic video image 150.

User interface 116 can be a visual user interface, acoustic user interface, tactile user interface, a combination thereof, and the like. Hence, user interface 116 can be a touch screen, a combination of a display and a pointing device, a combination of a display and a sound detector, and the like. For example, operator 118F can navigate through the menu in each of auxiliary images 158, 160, 162, and 164, via the sound detector of user interface 116.

Operator 118F has access to user interface 116. User interface 116 displays an image which can be also projected to the audience as an auxiliary image, such as auxiliary image 158 of FIG. 5A.

With reference to FIG. 5A, user interface 116 (FIG. 1) and beam combiner 106 both display an auxiliary image 158. Auxiliary image 158 is an image of a menu of different options for operator 118F to select from. Auxiliary image 158 can include different options representing different aircraft models, for example, an option 168 representing an F16 fighter plane, an option 170 representing a Cobra helicopter, and an option 172 representing a Cessna aircraft 120. Operator 118F can navigate in the menu via a pointing device (not shown), by touching the display of user interface 116 (in case of a touch screen), and the like. When operator 118F selects, for example, option 170, processor 112 (FIG. 4) retrieves data respective of an auxiliary image of a plurality of flight options from database 114. Database 114 stores data respective of a plurality of auxiliary images and a plurality of panoramic images, including the images per se, such as complete video images.

Processor 112 directs user interface 116 to display a particular auxiliary image, and projector 110 to project the particular auxiliary image on beam combiner 106 via reflector 108, toward the audience. The auxiliary image can include for example an option representing a combat scenario, an option representing an assault scenario, an option representing an attack scenario, an option representing a training scenario, and an option representing a navigation scenario.

Processor 112 furthermore retrieves data respective of a panoramic video image 150, which corresponds to an external environment which the pilot of an aircraft, (e.g., an F-16) would see though the cockpit during a training flight. Processor 112 directs projectors 104A, 104B, and 104C, to project different portions of panoramic video image 150 on panoramic projection screen 102, thereby enabling the audience to view panoramic video image 150.

Auxiliary image 160 in FIG. 5B is an image of the cockpit as the pilot would see (i.e., the instrument panel) while flying the aircraft. Auxiliary image 160 can include an image 174 of a two-dimensional map of the ground below the aircraft, an image 176 of a three-dimensional map of the ground below the aircraft, and an image 178 of flight data.

With reference to FIG. 5D, when operator 118F selects to enlarge auxiliary image 164 to be displayed as a full screen, processor 112 directs projector 110 to project auxiliary image 164 as a full auxiliary image on beam combiner 106, via reflector 108, toward the audience. Projectors 104A, 104B, and 104C continue to project panoramic video image 150 on panoramic projection screen 102. Auxiliary image 164 includes flight data respective of an F16 during flight training, such as altitude, airspeed, heading, remaining fuel, engine temperature, and the like, which the pilot would see on the HUD, in synchrony with panoramic video image 150.

The following is a description of a method for producing a substantially seamless image of panoramic video image 150, which is performed during calibration of system 100. Processor 112 directs projectors 104A, 104B, and 104C to project different portions of panoramic video image 150, on sections S_{A} (FIG. 3), S_{B}, and S_{C}, respectively, of panoramic projection screen 102. Due to the relative locations of projectors 104A, 104B, and 104C, there is generally a discrepancy between the images on sections S_{A}, S_{B}, and S_{C}, and these images are generally misaligned or out of scale relative to one another.

System 100 can further include an image detector (not shown) coupled with the processor. The image detector detects the images which projectors 104A, 104B, and 104C project on panoramic projection screen 102. Processor 112 determines the discrepancy between every adjacent pair of these images, by processing the detected images. Processor 112 modifies the images by substantially eliminating the discrepancies, and each of projectors 104A, 104B, and 104C projects the respective modified image on panoramic projection screen 102, thereby enabling the audience to obtain a substantially flawless and seamless view of panoramic video image 150.

For example, processor 112 determines that there is a gap (not shown) between an adjacent pair of images projected on sections S_{A} and S_{B}, and hence, projector 112 modifies these pair of images, such that this gap is substantially eliminated from the modified pair of images projected by projectors 104A and 104B, respectively. If the gap is substantially in the form of a rectangle, then processor 112 performs a translation between these pair of images. If the gap is substantially in the form of a trapezoid, then processor 112 performs a translation and a rotation between these pair of images. The gap can be either along a horizontal axis (not shown) of panoramic projection screen 102, along a vertical axis thereof (not shown), or inclined to the horizontal axis.

As a further example, processor 112 determines that the pair of adjacent images projected on panoramic projection screen 102 by projectors 104B and 104C, are of different scales, and hence processor 112 modifies these pair of images to substantially unify the absolute scales thereof. Once projectors 104A, 104B, and 104C project the respective modified images, the audience perceives panoramic video image 150 on panoramic projection screen 102, in a substantially flawless and seamless manner, as if viewing the environment around the aircraft from inside the cockpit of the aircraft.

Alternatively, processor 112 can calibrate system 100 according to a plurality of fiducials (i.e., landmarks) located at the edges of adjacent pairs of the images. A first calibration image (not shown) projected by projector 104B on section S_{B}, can include for example, a first fiducial (not shown) at an upper left corner thereof, and a second fiducial (not shown) at a lower left corner thereof. A second calibration image (not shown) projected by projector 104A on section S_{A}, can include a third fiducial (not shown) at an upper right corner thereof, and a fourth fiducial (not shown) at a lower right corner thereof. If there is a gap (not shown) between the first calibration image and the second calibration image, then according to an output of the image detector detecting the first calibration image and the second calibration image, processor 112 detects this gap, and determines that the first fiducial is not aligned with the third fiducial, and that the second fiducial is not aligned with the fourth fiducial.

Processor 112 controls the operation of projectors 104A and 104B, such that the first fiducial is aligned with the third fiducial, and the second fiducial is aligned with the fourth fiducial. In this manner, the images which projectors 104A and 104B project on panoramic projection screen 102 during a real-time operation of system 100, on sections S_{A} and S_{B}, respectively, are substantially of the same scale, and furthermore any gaps between the images are eliminated.

As a result of the alignment procedure of the fiducials, a left edge (not shown) of the first image and a right edge (not shown) of the second image can overlap. In this case, processor 112 can control the operation of projectors 104A and 104B, such that the left edge and the right edge are eliminated from images which projectors 104A and 104B project on panoramic projection screen 102, for example by cropping a portion of the images. In this manner, projectors 104A and 104B project the left image and the right image, such that substantially no overlap exists there between, and panoramic video image 150 is substantially seamless.

Projector 110 projects an auxiliary image, such as auxiliary image 162 (FIG. 5C), which should also spatially conform to panoramic video image 150. If auxiliary image 162 includes a two-dimensional map such as auxiliary image 162 (FIG. 5C), then in addition to temporal synchronization of auxiliary image 162 with panoramic video image 150, the spatial synchrony thereof should also be provided. The spatial synchrony can optionally be performed by methods analogous to those described above with reference to the production of a substantially seamless image of panoramic video image 150.

Alternatively, projector 110 can be located below beam combiner 106. In this case, projector 110 projects the auxiliary image on beam combiner 106, and beam combiner 106 reflects the auxiliary image toward the audience. Thus, the reflector can be eliminated from the system. It is noted that the beam combiner can be oriented at an angle of, for example, 45 degrees clockwise, with respect to an optical axis between the panoramic projection screen and the audience. In this case, the projector is located directly above the beam combiner, the reflector can be eliminated from the system, and the beam combiner reflects the auxiliary image directly toward the audience.

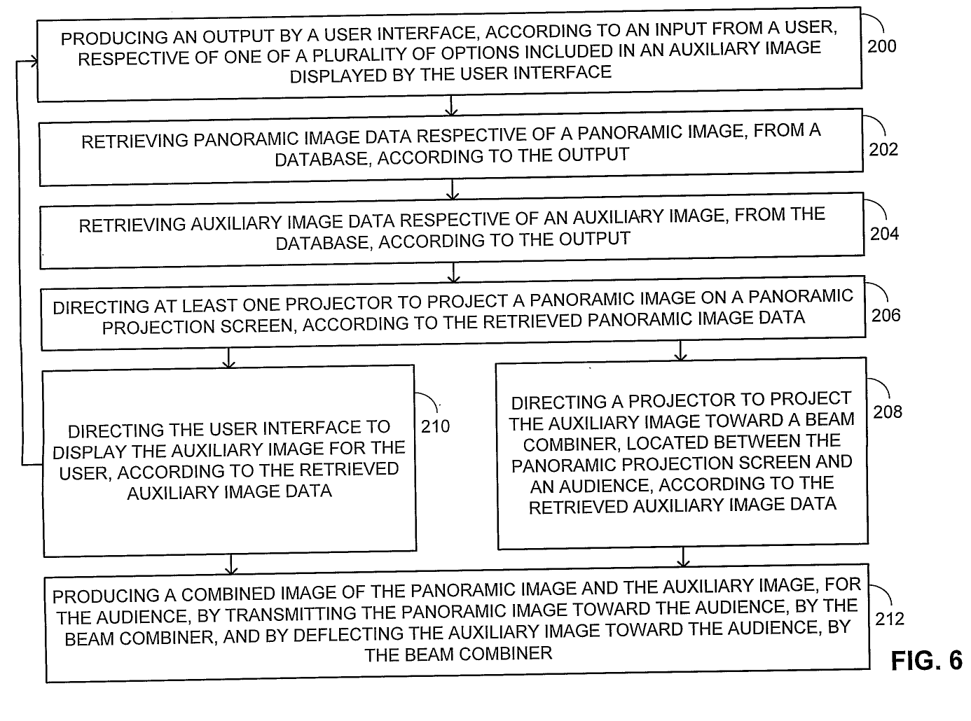

Reference is now made to FIG. 6, which is a schematic illustration of a method for operating the system of FIG. 1, operative according to another embodiment of the disclosed technique. In procedure 200, an output is produced by a user interface, according to an input from a user, respective of one of a plurality of options included in an auxiliary image displayed by the user interface. With reference to FIGS. 1, 4, and 5B, operator 118F selects option 174 among options 174, 176, and 178, in auxiliary image 160 displayed on user interface 116. User interface 116 produces an output according to this selection by operator 118F, and sends this output to processor 112.

In procedure 202, panoramic image data respective of a panoramic image is retrieved from a database, according to the output. With reference to FIGS. 4 and 5C, processor 112 retrieves panoramic image data respective of panoramic video image 150, according to the selection of option 174 by operator 118F in procedure 200.

In procedure 204, auxiliary image data respective of an auxiliary image is retrieved from the database, according to the output. With reference to FIGS. 4, 5B, and 5C, processor 112 retrieves auxiliary image data respective of auxiliary image 162, according to the selection of option 174 by operator 118F in procedure 200.

In procedure 206, at least one projector is directed to project a panoramic image on a panoramic projection screen, according to the retrieved panoramic image data. With reference to FIGS. 1, 4, and 5C, processor 112 directs projectors 104A, 104B, and 104C, to project panoramic video image 150, on panoramic projection screen 102, according to the panoramic image data which processor 112 retrieved from database 114, in procedure 202.

In procedure 208, a projector is directed to project the auxiliary image toward a beam combiner, located between the panoramic projection screen and an audience, according to the retrieved auxiliary image data. With reference to FIGS. 1, 4, and 5C, processor 112 directs projector 110 to project auxiliary image 162 on beam combiner 106, according to the auxiliary image data which processor 112 retrieved from database 114 in procedure 204. Beam combiner 106 is located between panoramic projection screen 102 and the audience (viewers 118A, 118B, 118C, 118D, 118E, and operator 118F).

In procedure 210, the user interface is directed to display the auxiliary image for the user, according to the retrieved auxiliary image data. With reference to FIGS. 1, 4, and 5C, processor 112 directs user interface 116 to display auxiliary image 162, according to the auxiliary image data which processor 112 retrieved from database 114 in procedure 204, for operator 118F. It is noted that procedures 208 and 210 are performed simultaneously.

In procedure 212, a combined image of the panoramic image and the auxiliary image is produced for the audience, by transmitting the panoramic image toward the audience, by the beam combiner, and by deflecting the auxiliary image toward the audience, by the beam combiner. Deflecting by the beam combiner can include reflecting or refracting the auxiliary image toward the audience. With reference to FIGS. 1, and 5C, beam combiner 106 produces a combined image for viewers 118A, 118B, 118C, 118D, 118E, and operator 118F. Beam combiner 106 produces this combined image by transmitting panoramic video image 150 there through, and by reflecting auxiliary image 162. It is noted that following procedure 210, the method can return back to procedure 200, for the user to select another option in the auxiliary image displayed in procedures 208 and 210.

It will be appreciated by persons skilled in the art that the disclosed technique is not limited to what has been particularly shown and described hereinabove. Rather the scope of the disclosed technique is defined only by the claims, which follow.

1. System for simulating, to an audience, a view from a cockpit of an aircraft, the cockpit including a head-up display, the system comprising:
a concave panoramic projection screen;
at least one panoramic projector for projecting a panoramic image on said concave panoramic projection screen, said panoramic image simulating a view of outside scenery as seen by a pilot from said cockpit, said panoramic image being viewed by said audience;
a beam combiner located between said concave panoramic projection screen and said audience;
an auxiliary projector for projecting an auxiliary image toward said beam combiner for simulating its display on said head-up display, said beam combiner producing a combined image of said panoramic image and said auxiliary image, for said audience, by transmitting at least part of said panoramic image toward said audience, and reflecting said auxiliary image toward said audience, such that said auxiliary image appears closer to said audience than said panoramic image;
a database for storing panoramic image data respective of said panoramic image, and auxiliary image data respective of said auxiliary image;
a user interface for displaying said auxiliary image for a user among said audience, said user interface producing an output according to an input from said user, respective of one of a plurality of options included in said auxiliary image; and
a processor coupled with said at least one panoramic projector, said auxiliary projector, said database, and with said user interface, said processor retrieving said panoramic image data from said database, according to said output, said processor retrieving said auxiliary image data, according to said output, said processor directing said at least one panoramic projector to project said panoramic image on said panoramic projection screen, according to said panoramic image data, said processor directing said auxiliary projector to project said auxiliary image on said beam combiner, according to said auxiliary image data, wherein said panoramic image and said auxiliary image are temporally and spatially projected in synchrony.

2. The system according to claim 1, further comprising a reflector located below said beam combiner,
wherein said auxiliary projector is located above said reflector and said beam combiner,
wherein said auxiliary projector projects said auxiliary image on said reflector, and
wherein said reflector reflects said auxiliary image toward said beam combiner.

3. The system according to claim 1, wherein said beam combiner is selected from the list consisting of:
semitransparent glass plate;
semitransparent plastic plate;
transparent glass plate; and
transparent plastic plate.

4. The system according to claim 1, wherein said auxiliary image is selected from the list consisting of:
menu;
cockpit of an aircraft; and
informative data.

5. The system according to claim 1, wherein at least one of said panoramic image and said auxiliary image is selected from the list consisting of:
still; and
video.

6. The system according to claim 1, wherein said at least one panoramic projector comprises a plurality of panoramic projectors and wherein each of said panoramic images is substantially seamless.

7. The system according to claim 1, wherein said user interface is selected from the list consisting of:
visual;
acoustic; and
tactile.

8. Method for simulating, to an audience, a view from a cockpit of an aircraft, the cockpit including a head-up display, the method comprising the procedures of:
producing an output, according to an option selected by a user among a plurality of options;
retrieving panoramic image data and auxiliary image data from a database, according to said output;
directing at least one panoramic projector to project said panoramic image on a concave panoramic projection screen, according to said panoramic image data;
directing an auxiliary projector to project said auxiliary image toward a beam combiner, located between said concave panoramic projection screen and said audience, according to said auxiliary image data; and producing a combined image of said panoramic image and said auxiliary image, for said audience, by transmitting said panoramic image toward said audience, by said beam combiner, and by deflecting said auxiliary image toward said audience, by said beam combiner, such that said auxiliary image appears closer to said audience than said panoramic image.

9. The method according to claim 8, wherein said procedure of producing said combined image comprises the sub-procedure of projecting said panoramic image and said auxiliary image in temporal and spatial synchrony.

10. The method according to claim 8, wherein said procedure of directing said auxiliary projector comprises sub-procedures of:
directing said auxiliary projector to project said auxiliary image toward a reflector located below said beam combiner; and
reflecting said auxiliary image by said reflector toward said beam combiner.

11.-12. (canceled)
